(19) United States
(12) Patent Application Publication
(10) Pub. No.: US 2015/0344212 A1
(43) Pub. Date: Dec. 3, 2015

(54) SINGLE-USE PILL DISPENSER

(71) Applicants: John Melendez, Norwalk, CA (US); Constance Melendez, Norwalk, CA (US)

(72) Inventors: John Melendez, Norwalk, CA (US); Constance Melendez, Norwalk, CA (US)

(21) Appl. No.: 14/295,288

(22) Filed: Jun. 3, 2014

(51) Int. Cl. B65D 83/04; B65D 5/02; B65D 5/42; A61J 1/03

(52) U.S. Cl. CPC B65D 83/04; A61J 1/03; B65D 5/0227; B65D 5/4266; B65D 2583/0404; B65D 2585/56

(57) ABSTRACT

A single-use pill dispenser is fabricated from a moisture-resistant, recyclable material and includes a lipped, hollow body that has crush-resistant side walls. An integral folding closure involves one or more flaps which are formed by folding the lip of the hollow body in any of various configurations that are indicated by pre-made scores. The one or more flaps may then be folded into a closed position along additional pre-made scores. Folding along the pre-made scores biases the flaps to the closed position, protecting the contents therein from spillage and environmental contamination. In embodiments, the single-use pill dispenser is also operative as a drinking vessel. In embodiments, the single-use pill dispenser carries a printed form having blanks for entering information regarding contents and/or user.

### BACKGROUND OF THE INVENTION

1. Field of the Invention

In general, the subject matter herein described is related to dispensing of pills. More particularly, it is related to a single-use pill dispenser.

2. Background Information

The practice of dispensing pre-measured amounts of medicinal substances in pill form is ancient—perhaps going back to the 15^{th} century BCE. It is safe to say that the problem of how to dispense pills easily, shield them from damage and environmental insult, preserve their medicinal qualities, and transport them in useful quantities is almost as ancient as pills themselves.

When pillboxes come to mind, one usually thinks of small ornate boxes with hinged lids made from precious or semi-precious materials such as gold, silver, ivory, glass and porcelain. In fact, museums and websites for antique dealers show any number of examples of such pillboxes. While such pillboxes served adequately as containers for pills, they were intended as keepsakes and trinkets as much as they were intended to hold pills. They were typically small and easily lost if removed from the home environment and carried with the box's owner. Additionally, because they were hand-manufactured by skilled craftsman from rare materials, they were expensive luxury items available only to the wealthy and privileged. Furthermore, they were easily damaged when removed from the home environment and not easily replaced if lost or damaged. As such, they were not intended for single use.

Until only a few decades ago, medications in the form of pills were taken mostly by the aged or the very ill. Otherwise, taking pills was a relatively rare event in the life of the average person. Because people only took pills when they were quite sick, needing to carry pills with them when they left their homes or when they traveled was fairly unusual. Also, complicated medication regimens involving taking several different pill types at different times of day and needing to be on such a regimen for an extended period was unusual. As pharmaceutical science continues to advance and prescription drugs are developed for more and more indications, it is becoming more and more common, even for people in relatively good health, to be on complex regimens that need to be dosed several times per day. The problem of managing complicated pill regimens in places outside of the home, such as on vacation, is of relatively recent origin.

The problems of managing complicated pill regimens are no longer limited just to those taking prescription medications. It has become common for people to place themselves on regimens of nutritional supplements that may require them to take tens of different pills or capsules at different times of day. In fact, some supplement regimens easily rival the most involved regimens of prescription drugs in their complexity.

There are a number of daily, or weekly or monthly pill organizers that serve as pill dispensers while assisting in the management of a medication or supplement regimen. Many of these are compartmented organizers having separate compartments for each day or for each pill-taking occasion. Each compartment may be provided with a hinged lid that snaps into place. Typically such organizers are injection-molded from one petroleum-based polymer or another.

There are a number of disadvantages associated with such pill organizers. First, is that, with continued use, the hinged lids fatigue and no longer are able to stay closed. Thus, a user, while traveling, for example, runs the risk that his or her pills may be spilled in his or her bag while traveling. A related problem is that the hinge eventually fails completely after extended use and the lid comes off, rendering the entire unit substantially unusable. A further disadvantage with such organizers is the petroleum-based polymeric materials from which they are usually manufactured, which are significant environmental contaminants due to the many thousands of years it takes such materials to biodegrade once they are discarded. A still further disadvantage to such pill organizers is that they are often of unwieldy size. Some pill organizers are even the size of a small tool case or tackle box, taking up needless space in a user's luggage or, actually, because of their size, constituting an additional piece of luggage for the user to carry. Yet another disadvantage with such organizers is that their portability is limited. A traveler, for example, if he or she wanted to take morning meds or vitamin pills along to take with breakfast, would be unlikely to bring a pill organizer the size of a tackle box to breakfast. Thus, the traveler would be forced to portion out the pills and find another container in which to carry the portion to breakfast.

Occasionally, people portion out pills in small envelopes or ZIP-LOC bags. Unfortunately, such containers offer no resistance to impact or other external insults, exposing the pills within to risk of crushing and other damage.

### SUMMARY

A single-use pill dispenser is fabricated from a moisture-resistant, recyclable material and includes a lipped, hollow body that has crush-resistant side walls. An integral folding closure involves one or more flaps which are formed by folding the lip of the hollow body in any of various configurations that are indicated by pre-made scores. The one or more flaps may then be folded into a closed position along additional pre-made scores. Folding along the pre-made scores biases the flaps to the closed position, protecting the contents therein from spillage and environmental contamination. In embodiments, the single-use pill dispenser is also operative as a drinking vessel. In embodiments, the single-use pill dispenser carries a printed form having blanks for entering information regarding contents and/or user.

The features and advantages described in this summary and in the following detailed description are not all-inclusive, and particularly, many additional features and advantages will be apparent to one of ordinary skill in the relevant art in view of the drawings, specification, and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF THE DRAWINGS

FIG. 1 shows a front elevation of a single-use pill dispenser having a pre-scored multi-fold enclosure;

FIG. 2 shows a side elevation of a single-use pill dispenser having a pre-scored multi-fold enclosure;

FIG. 3 shows an embodiment of a scoop-sided single-use pill dispenser having a pre-scored folding closure;

FIGS. 4A and B show an embodiment of a single-use pill dispenser having a pre-scored four-fold closure;

FIG. 5 shows an embodiment of a single-use pill dispenser having a simple flap closure;

FIGS. 6A and B show an embodiment of a single-use pill dispenser having a bi-flap closure;

FIG. 7 shows an embodiment of a single-use pill dispenser having a single-flap closure

FIG. 8 shows an embodiment of a single-use pill dispenser having a pre-scored four-fold slotted closure; and

FIGS. 9A-D show different embodiments of a printed form on an exterior surface of a single-use pill dispenser having fillable blanks.

### DETAILED DESCRIPTION

A single-use pill dispenser is fabricated from a moisture-resistant, recyclable material and includes a lipped, hollow body that has crush-resistant side walls. An integral folding closure involves one or more flaps which are formed by folding the lip of the hollow body in any of various configurations that are indicated by pre-made scores. The one or more flaps may then be folded into a closed position along additional pre-made scores. Folding along the pre-made scores biases the flaps to the closed position, protecting the contents therein from spillage and environmental contamination. In embodiments, the single-use pill dispenser is also operative as a drinking vessel. In embodiments, the single-use pill dispenser carries a printed form having blanks for entering information regarding contents and/or user.

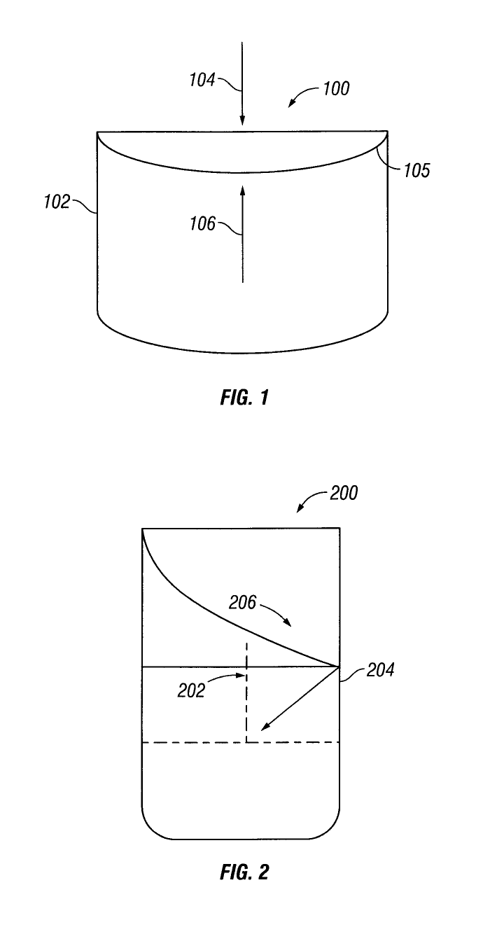

Referring now to FIG. 1, shown 100 is an embodiment of a disposable pill dispenser that includes a hollow body 102 having curved sides and two facing cover flaps 104, 106, which, when folded inward, one after the other, form an integral folded closure that confines the contents to the dispenser and shields the contents from the outside environment. As shown, the embodiment 100 of FIG. 1 may be a cylinder having a continuously-curving side that rises to the lip of the cylinder from the base at a right angle. In other embodiments, the dispenser may form a conical cylinder having a continuously-curving side that rises to the lip of the cylinder at an acute inside angle. Embodiments of the pill dispenser of FIG. 1 are fabricated from a cellulosic material, such as paper, having at least a water-resistant interior surface. In embodiments, the lip of the cylinder may be formed by rolling the body material to form a circular structure that defines and reinforces the top edge of the lip, and therefore, the entire cylinder. Additionally, the lip provides a smooth edge that renders the dispenser suitable as drinking vessel. Embodiments are provided having water-resistant interior and exterior surfaces. The water-resistant surface may be achieved by coating the paper with any of a variety of polymeric varnishes that are no more than slightly permeable to water and/or oil, such as PLATE-KOTE, provided by MICHELMAN, Inc. (Cincinnati, Ohio).

The facing cover flaps 104, 106 shown in FIG. 1 may be formed by providing pre-made scores on opposing sides of the cylinder and then folding the lip inward toward the center of the cylinder along an arc defined by the score. A first score 108 may be made that extends from the beginning to the end of a first arc on the lip of the cylinder. The score may curve downward on the side of the cylinder until it reaches its lowest point at the midpoint between the beginning and the end of the arc on the cylinder lip, at which point, the curve continues upward from the midpoint to the end of the arc, forming a mirror image of the first half of the curve. A second score (not shown), identical to the first may be provided at an angle of 180° to the first score. An end user may then form the cover flaps 104, 106 by pressing, for example with his or her thumbs, inward on the lip along the first score 108, thereby causing the lip to fold inward toward the center of the cylinder, forming a flap. The user then performs the identical operation along the second score, thereby forming a second flap that folds down over the first flap.

In embodiments, the scores are provided in such a way as not to create pointed edges, which create discomfort when carried in the pockets of lightweight clothing.

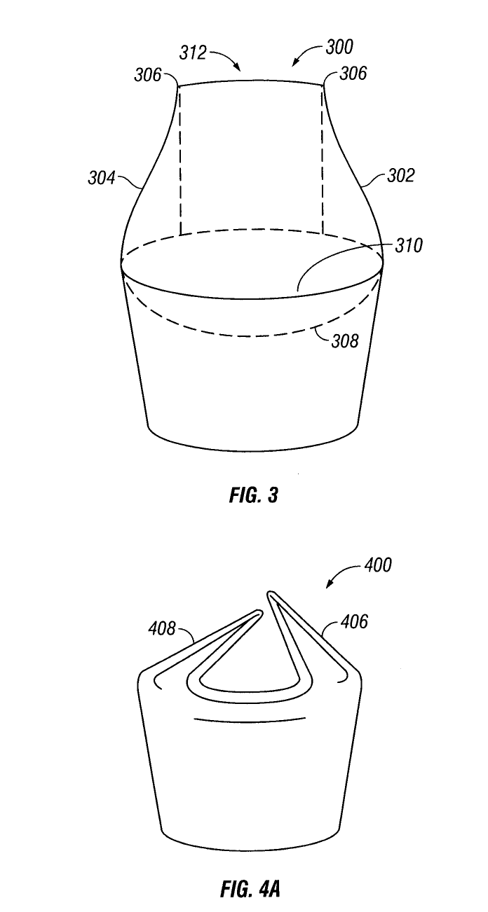

Turning now to FIGS. 2 and 3, shown is an embodiment of a single-use pill dispenser having a cylindrical hollow body wherein portions of the lip 302, 304 dip to form a shape resembling a scoop, thereby eliminating a significant portion of the surface area of the side wall of the cylindrical body 306, allowing flaps of smaller size to be created. FIG. 2 provides a side elevation 200 of the present embodiment and FIG. 3 provides an isometric view 300 of the same embodiment. As in the embodiment of FIG. 1, the present embodiment may have a body that is either a straight or a conical cylinder. The present embodiment may be provided with an integral folding closure based on four folds that forms a tightly-closed parcel able to securely contain the contents and shield them from damage and degradation. Additionally, any external edges are rounded to avoid the formation of any sharp points in the dispenser in its folded configuration, thereby minimizing the possibility that the user will be subjected to undue discomfort while carrying the parcel in his/her pocket. Pre-made scores 306 are provided that facilitate first folding the downward-curving portions 302, 304 of the side wall that forms the scoop. In embodiments, opposing downward-curving lip portions may be folded inward 202, first one, followed by the other, toward the hollow center of the cylindrical body. In embodiments, the downward-curving sidewall portions 302,304 may instead be folded, first one, followed by the other, in an outward direction. Folding the downward-curving sidewall portions leaves two portions that are raised relative to the two folded downward-curving sidewall portions. First one 310 of the elevated sidewall portions may be folded inward 204 toward the hollow center of the cylindrical body, followed by the second one of the raised sidewall portions. In embodiments, the raised sidewall portion formed at the bottom of the scoop may be folded inward first followed by 206 its opposing sidewall portion 312, which is that portion of the sidewall having the intact lip. Pre-made scores 308 are provided to facilitate folding of the closure.

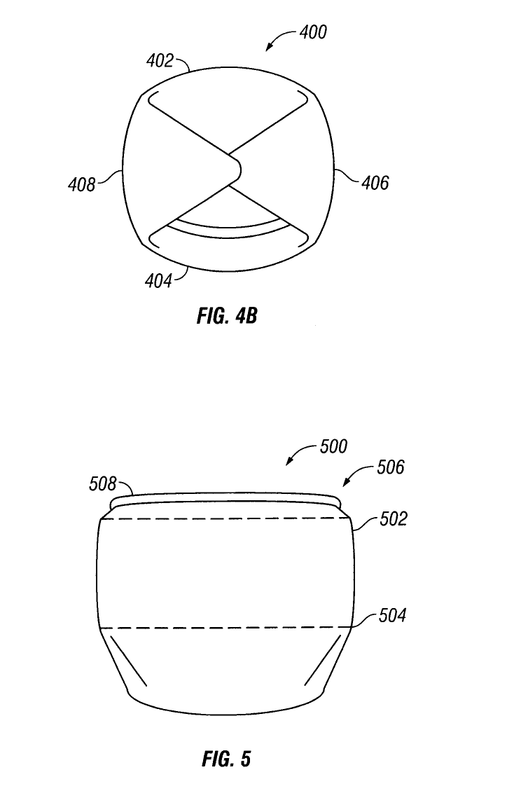

FIGS. 4A and B show a further embodiment 400 of a single-use pill dispenser having a multi-fold closure 400. As shown, pre-made scores are provided that facilitate folding the lip toward the center of the body at points 402, 404 opposed to each other 180°, which forms two longitudinal flaps 406, 408 also opposed to each other 180°. Pre-made scores are provided to facilitate folding the two longitudinal flaps inward toward the center of the hollow body to achieve closure of the dispensing device.

Folding along the pre-made scores biases the flaps to the closed position, thus providing a secure closure.

FIG. 5 shows an embodiment 500 of a single-use pill dispenser having a simple flap closure. Pre-made scores 506, 508 are provided on the lip and side wall at two points 180° opposed to each other. By folding the dispenser at the two opposing points 506, 508, the user flattens the upper portion of the cylindrical body until opposing portions of the wall substantially contact each other. Pre-made scores 502, 504 are provided latitudinally that facilitate folding the flattened upper portion down on itself at least one time. In embodiments, multiple latitudinal scores 502, 504 are provided at spaced intervals, allowing the user to fold the flattened upper portion over on itself multiple times.

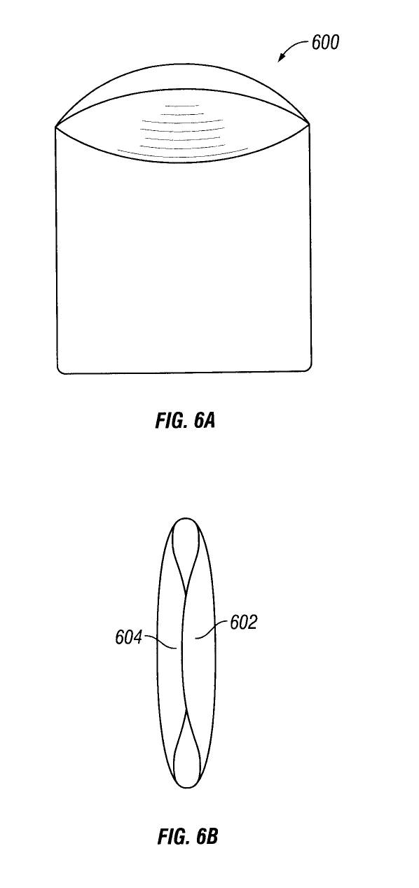

FIGS. 6A and 6B show an embodiment 600 of a single-use pill dispenser having opposing curved sides and a pair of facing cover flaps, 602, 604 as in the embodiment of FIG. 1. FIG. 6A shows a side elevation of the present embodiment with the cover flaps in their open position. FIG. 6B shows a plan view of the present embodiment with the cover flaps 602, 604 in the closed position.

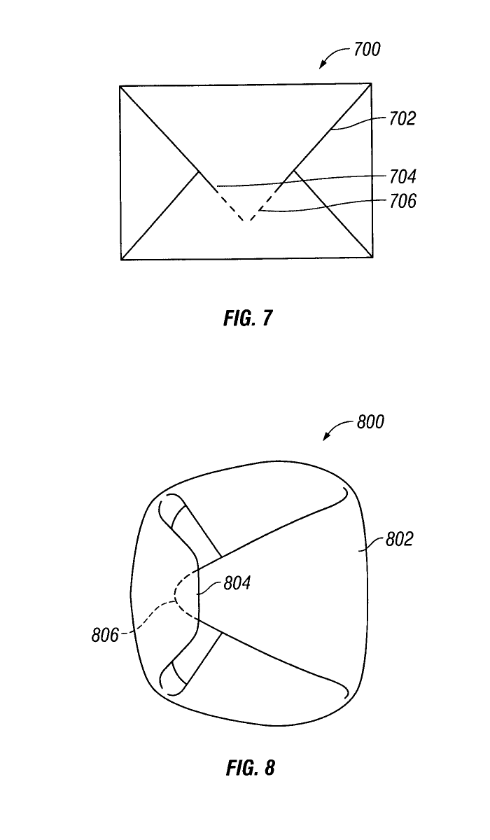

FIG. 7 shows an embodiment 700 of a single-use pill dispenser having a single-flap 702 closure. In an embodiment, the dispenser may have a substantially flat body formed from two opposing sides. In embodiments, the two opposing sides may be connected by pleated panels (not shown) that permit the dispenser to be stored in a substantially flat configuration and which, by virtue of the pleated panels, may then expand to significantly increase the volume of the dispenser. In an embodiment, the dispenser is provided with a scored flap 702 that is integral with a first one of the two sides. In use, the scored flap is folded downward over the opposing side and secured in the closed position. In an embodiment, the flap is pointed 706 and is secured by inserting the point into a horizontal slot 704 provided in the side of the dispenser over which the flap is folded. In embodiments, the flap is secured by means of an adhesive strip (not shown) provided on the facing side of the flap, which adheres the flap to the side of the dispenser over which the flap is folded.

FIG. 8 shows an embodiment 800 of a single-use pill dispenser having a pre-scored four-fold slotted closure. Similar to the embodiment of FIG. 4, at least one of the two opposing flaps formed when the lip portions are folded inward toward the center of the body forms a point 806. The opposing flap is provided with a slotted opening 804 which, when the flap 802 is folded into place provides a receptacle for the point 806 of the pointed flap. The flaps are secured by the user inserting the point 806 of the pointed flap into the receptacle 804 on the opposing flap, thus providing a secure closure.

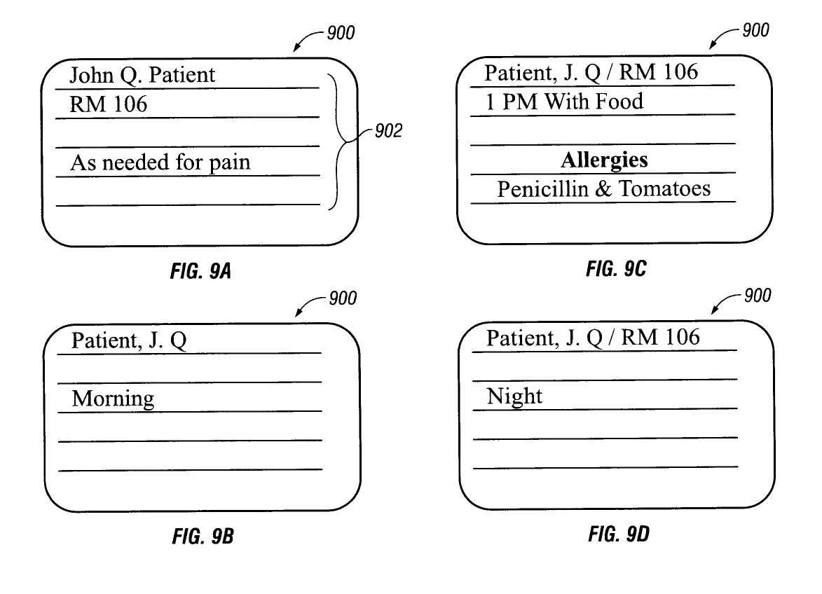

As shown in FIGS. 9A-D, embodiments may include a printed form 900 on an exterior surface of the dispenser having fillable blanks 902 in which dispensing information and other notes and reminders may be entered. In various embodiments, dispensing information may include:

name of the person for whom the medication is intended;

a room number or other location information, such as address or suite number;

an indication;

dispensing time;

additional instructions, such as “with food”; and

allergies.

The foregoing list is not meant to be limiting. Other versions of the printed form will occur to a person having an ordinary level of skill in the art.

In embodiments, the form may be provided on any surface of the dispenser having sufficient unobstructed area. In embodiments, the form may be provided on the bottom surface of the dispenser.

In actual practice, the user may purchase the single-use pill dispenser in multiples as a packaged consumer product distributed through national, regional or local sales outlets such drug stores, grocery stores, discount retailers, warehouse clubs and so on. A typical use scenario may involve the user portioning out pills for a single pill-taking occasion. The user may then fill in the one or more of the blanks of the exterior form to remind him/her exactly when the particular portion is to be taken. The user may then deposit the pills in the single-use dispenser, and activate the closure to produce a small parcel. The user may then repeat the operation for as many pill-taking occasions as he or she may wish to prepare for. Many additional use scenarios will occur to those of ordinary skill; however the single-use pill container is very helpful in situations requiring the user to carry pills for several pill-taking occasions along when he or she is outside of the home, for example, in the workplace, or on vacation. It is to be appreciated that embodiments of the single-use pill dispenser may have a cup shape and a lip that renders them suitable to drink from—an additional convenience when the user actually needs to take the pills. To remove the pills, the user may open the closure. However, due to the single-use nature of the pill dispenser, maintaining structural integrity is not a priority, thus the user may desire simple to tear the parcel containing the pills open and discard the used dispenser.

Embodiments may also be realized as medication-dispensing devices deployed in health care institutions such as hospitals, clinics, nursing homes, and so on, wherein it is desirable to provide a single-use dispensing solution that minimizes possibility both of medication errors and cross-contamination from patient to patient. Embodiments may be realized as amenities provided in small hospitality packages and distributed for example, to hotel guests and restaurant patrons.

As will be understood by those familiar with the art, the subject matter may be embodied in other specific forms without departing from the spirit or essential characteristics thereof. For example, in embodiments, the hollow body from which the single-use pill dispenser is formed may also be a polyhedron. Additionally, in embodiments, the hollow body may be fabricated from any of several plant-based polymers made, for example, from corn or soybeans.

The foregoing description, for purpose of explanation, has been described with reference to specific embodiments. However, the illustrative discussions above are not intended to be exhaustive or limiting to the precise forms disclosed. Many modifications and variations are possible in view of the above teachings. The embodiments were chosen and described in order to best explain relevant principles and their practical applications, to thereby enable others skilled in the art to best utilize various embodiments with or without various modifications as may be suited to the particular use contemplated.

1. A single-use pill dispenser comprising:
a hollow body having crush-resistant side walls and fabricated from a moisture-resistant, recyclable material; and
a folding closure integral to said body comprising a plurality of flaps, said flaps formed by folding at least one portion of a lip of said body inward toward a center of said hollow body at at least one point indicated by at least one pre-made score, wherein folding said flaps inward toward the center of said hollow body along second pre-made scores biases said flaps to remain in a closed position.

2. The pill dispenser of claim 2, wherein said plurality of flaps comprises:
a plurality of semi-rigid flaps, each of said semi-rigid flaps comprising a portion of said lip that remains in an original position of said lip after said at least one portion of said lip is folded toward the center of said hollow body, wherein, responsive to said at least one portion of the lip being folded inward toward a center of said hollow body, each of said semi-rigid flaps is folded inward toward a center of said hollow body along the second pre-made scores.

3. The pill dispenser of claim 2, further comprising a slotted securing device for securing said flaps in a closed position, said securing device comprising a slotted receptacle that receives a pointed end of at least one of said plurality of semi-rigid flaps to secure said at least one of said plurality of semi-rigid flaps in a closed position.

4. The pill dispenser of claim 1, further comprising at least one adhesive strip placed at a predetermined location on a side wall of said hollow body for securing at least one of said flaps in a closed position.

5. The pill dispenser of claim 1, wherein said hollow-body comprises one of:
a straight cylinder;
a conical cylinder; and
a polyhedron.

6. The pill dispenser of claim 1, wherein said moisture-resistant disposable material comprises one of:
a cellulosic material having a moisture-resistant surface coating; and
a plant-based polymer.

7. The pill dispenser of claim 4, wherein said moisture-resistant surface coating comprises a non-toxic varnish configured for contact with food and medication having moisture resistance and oil resistance.

8. The pill dispenser of claim 1, wherein said plurality of flaps comprises at least two but not more than four flaps.

9. The pill dispenser of claim 1, further comprising a form provided on an exterior surface of said hollow body for entering information relating to contents of said pill dispenser, conditions for use of the contents and information regarding an intended recipient of the contents.
